(19) United States
(12) Patent Application Publication
(10) Pub. No.: US 2013/0132948 A1
(43) Pub. Date: May 23, 2013

(54) PERSONAL CLOUD COMPUTING AND VIRTUAL DISTRIBUTED CLOUD COMPUTING SYSTEM

(71) Applicants: Adiseshu Hari, Holmdel, NJ (US); Ramesh Viswanathan, Manalapan, NJ (US); Yuh-Jye Chang, Hsinchu (TW); T.V. Lakshman, Morganville, NJ (US)

(72) Inventors: Adiseshu Hari, Holmdel, NJ (US); Ramesh Viswanathan, Manalapan, NJ (US); Yuh-Jye Chang, Hsinchu (TW); T.V. Lakshman, Morganville, NJ (US)

(21) Appl. No.: 13/300,937

(22) Filed: Nov. 21, 2011

(51) Int. Cl. G06F 9/455

(52) U.S. Cl. 718/1

(57) ABSTRACT

An exemplary cloud computing apparatus includes at least one compute device controller. A digital data storage of the controller includes a chief management virtual machine program for running a chief management virtual machine. A processor associated with the digital data storage is configured to run the chief management virtual machine. The chief management virtual machine is useful to control first user communications between at least one first user and a first virtual machine and to control second user communications between at least one second user and a second virtual machine. The first virtual machine and the second virtual machine are run by at least one compute resource distinct from the compute device controller. The chief management virtual machine is also useful for isolating the first user communications from the second user communications.

### BACKGROUND

Cloud computing is used for providing computing capabilities as a service. Computing resources such as software and information are shared among those accessing the cloud.

One reason why cloud computing is considered useful is that it lessens the burden on an entity that does not have the corresponding hardware or software that would otherwise be necessary for realizing desired computing capabilities. Rather than having to make a substantial investment in such resources, the same computing capabilities can be used by paying for access to those capabilities offered by a cloud service provider.

Another reason that cloud computing is recognized as beneficial is that it allows an entity that has unused computing capacity to realize the full potential of the equipment it currently has. For example, many businesses have computer networks that are over-provisioned with excess capacity to handle an occasional spike in activity or as a backup, for example. Most of the time that capacity remains idle and the owner does not realize any tangible benefit from that capacity (other than having it available if the need for it arises). Cloud computing can allow such capacity to be made available to others for a fee.

While several cloud architectures have been proposed and used, there has not been any suggested way to manage edge computing resources owned by an individual, for example, that could be offered to others for cloud computing.

### SUMMARY

An exemplary cloud computing apparatus includes at least one compute device controller. A digital data storage of the controller includes a chief management virtual machine program for running a chief management virtual machine. A processor associated with the digital data storage is configured to run the chief management virtual machine. The chief management virtual machine is useful to control first user communications between at least one first user and a first virtual machine and to control second user communications between at least one second user and a second virtual machine. The first virtual machine and the second virtual machine are run by at least one compute resource distinct from the compute device controller. The chief management virtual machine is also useful for isolating the first user communications from the second user communications.

Another exemplary cloud computing system includes at least one compute resource provided with a virtual machine program for running a first virtual machine that is available to at least one remotely located first user and running a second virtual machine that is available to at least one remotely located second user. A compute device controller is provided with a chief management virtual machine program for running a chief management virtual machine for controlling first user communications between the first virtual machine and the first user and controlling second user communications between the second virtual machine and the second user. The chief virtual management machine is also useful for isolating the first user communications from the second user communications.

An exemplary method of cloud computing includes providing a plurality of compute device controllers with respective chief management virtual machine programs for running respective chief management virtual machines. The chief management virtual machine of a compute device controller is used for controlling first user communications between at least one first user and a first virtual machine and controlling second user communications between at least one second user and a second virtual machine. The first virtual machine and the second virtual machine are run by at least one compute resource distinct from the compute device controller. The chief management virtual machine is also used for isolating the first user communications from the second user communications.

Another exemplary method of cloud computing includes providing at least one compute resource with a virtual machine program for running a first virtual machine that is available to at least one remotely located first user and running a second virtual machine that is available to at least one remotely located second user. A compute device controller is provided with a chief management virtual machine program for running a chief management virtual machine. The chief management virtual machine is used for controlling first user communications between the first virtual machine and the first user and for controlling second user communications between the second virtual machine and the second user. The chief management virtual machine is also used for isolating the first user communications from the second user communications.

The various features and advantages of disclosed examples will become apparent to those skilled in the art from the following detailed description. The drawings that accompany the detailed description can be briefly described as follows.

### BRIEF DESCRIPTION OF THE DRAWINGS

FIG. 1 schematically illustrates a personal cloud computing system designed according to an embodiment of this invention.

FIG. 2 is a flow chart diagram summarizing an example approach for controlling communications within the example system of FIG. 1.

FIG. 3 schematically illustrates selected portions of the example of FIG. 1 configured according to one example embodiment.

FIG. 4 schematically illustrates an example virtual, distributed cloud computing system configured according to an example embodiment.

FIG. 5 schematically illustrates selected portions of the example of FIG. 4 configured according to one example embodiment.

### DETAILED DESCRIPTION

The following description introduces a personal cloud arrangement and various techniques for sharing edge compute resources across the Internet. The personal cloud arrangement makes it possible for sharing compute resources over the

Internet among peers. The personal cloud may also be part of a virtual, distributed cloud that is managed by a service provider utilizing the resources of an aggregate of multiple personal clouds. The virtual, distributed cloud does not require its own infrastructure but, instead, takes advantage of the compute resources available in the personal clouds.

For discussion purposes, the term “personal cloud” is used to indicate a cloud that is established using equipment that is owned or controlled by a single entity. For example, equipment that is owned or controlled by an individual, small business or another identifiable entity. It is possible for a “personal” cloud consistent with disclosed examples to be established using equipment that is owned by a small business or another entity, for example.

The disclosed examples facilitate using otherwise underutilized edge compute resources such as those owned by an individual or another entity that can be considered an endpoint of the Internet. Examples of such resources include unused computers, CPUs and bandwidth. Such resources could be shared with others to provide datacenter services, backup services, applications or website operation services, for example. The term “compute resource” as used in this description is intended to refer to any of these as appropriate in a given context. For discussion purposes computers are selected as example compute resources.

One of the challenges presented by attempting to share edge compute resources is providing a framework for exporting the resources (e.g., CPU, network and storage) from individual nodes in a secure and scalable fashion. Disclosed examples include virtual machines (VMs) that effectively package such resources for use by remote users.

Another challenge is associated with setting up a personal cloud. Many people or entities that may offer compute resources to remote users in a manner consistent with the disclosed examples do not have sufficient expertise or experience to be able to configure the personal cloud. As will become apparent from the following description, the disclosed examples include an auto-configuring approach that minimizes user-driven configuration for setting up and managing the resource sharing.

Additionally, the disclosed examples include features that ensure that the resource shared VMs do not interfere with each other or any other computers that a personal cloud provider is using for their own purposes within the same environment as the resources offered to remote users.

The disclosed examples also facilitate multiple VMs sharing a single Internet Protocol (IP) address.

An example personal cloud arrangement is described followed by a description of a virtual, distributed cloud that is based on an aggregated plurality of personal clouds.

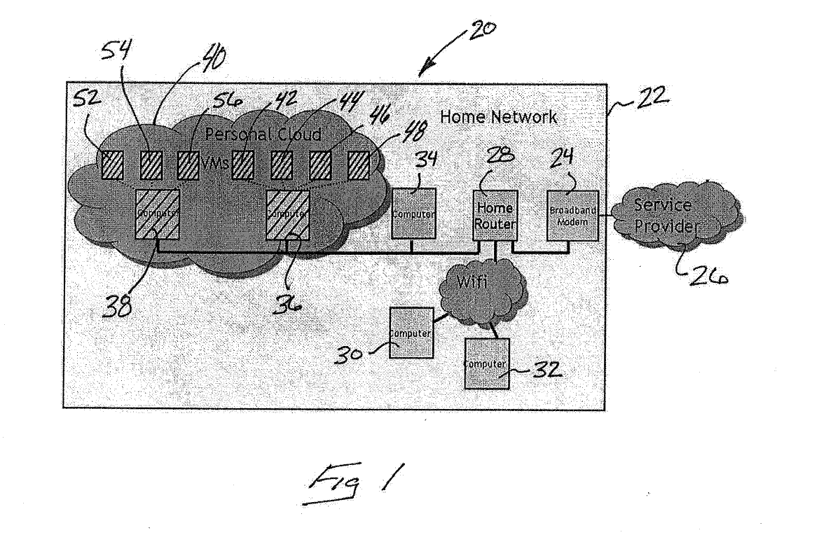

FIG. 1 schematically illustrates selected portions of an example personal cloud computing system 20. In the illustrated example, a personal network 22 includes an interface device 24 such as a modem that is useful for interfacing between the personal network 22 and an external network 26 such as the Internet. A compute device 28 such as a router facilitates communications between devices in the personal network 22 and the external network 26 through the interface device 24. The schematic divisions of the devices 24 and 28 in FIG. 1 are for discussion purposes only. Those skilled in the art will recognize that a single compute device may combine router and modem capabilities.

In this example, the compute device 28 comprises a router that facilitates wireless communications within the network 22 on behalf of computers 30 and 32. The compute device 28 also facilitates communications on behalf of computers 34, 36 and 38.

The computers 36 and 38 are each included in a personal cloud 40. The computers 36 and 38 are, in one example, computers that are otherwise not being used by the owner of the network 22. Those computers in this example are each provided with a virtual machine program for running a virtual machine (VM) that is available to one or more remote users that communicate with the VM. In the illustrated example, the computer 36 includes at least one virtual machine program that facilitates the computer 36 having four VMs 42, 44, 46 and 48 (i.e., four instances of the at least one virtual machine program). The illustrated computer 38 includes at least one virtual machine program that facilitates the computer 38 having three VMs 52, 54 and 56 (i.e., three instances of the at least one virtual machine program). Each of those VMs is useful for providing computing services or capabilities accessible by at least one authorized remote user. The term “remote” may refer to a user that is remote from the computers 36 and 38, remote from the network 22 or remote from both.

In one example, the virtual machine program or software can be installed on the computers 36 and 38 using known software installation techniques. One example virtual machine program installs a hypervisor, such as a known Type 1 native hypervisor, into the computer(s) to be included as part of the personal cloud. The computers 36 and 38 are dedicated exclusively to cloud computing use in this example.

In this example, the personal cloud 40 allows users to utilize the computing resources available through the computers 36 and 38 without having to own or maintain control over them. In one example, the computers 36 and 38 comprise x86 based computers dedicated to resource sharing through the cloud 40. They are powered on and connected to the network 22 whenever the cloud 40 is to be available to potential users. In this example, the VMs within the cloud 40 are exclusively used by authorized users that are remote from the computers 36 and 38 and outside of the network 22.

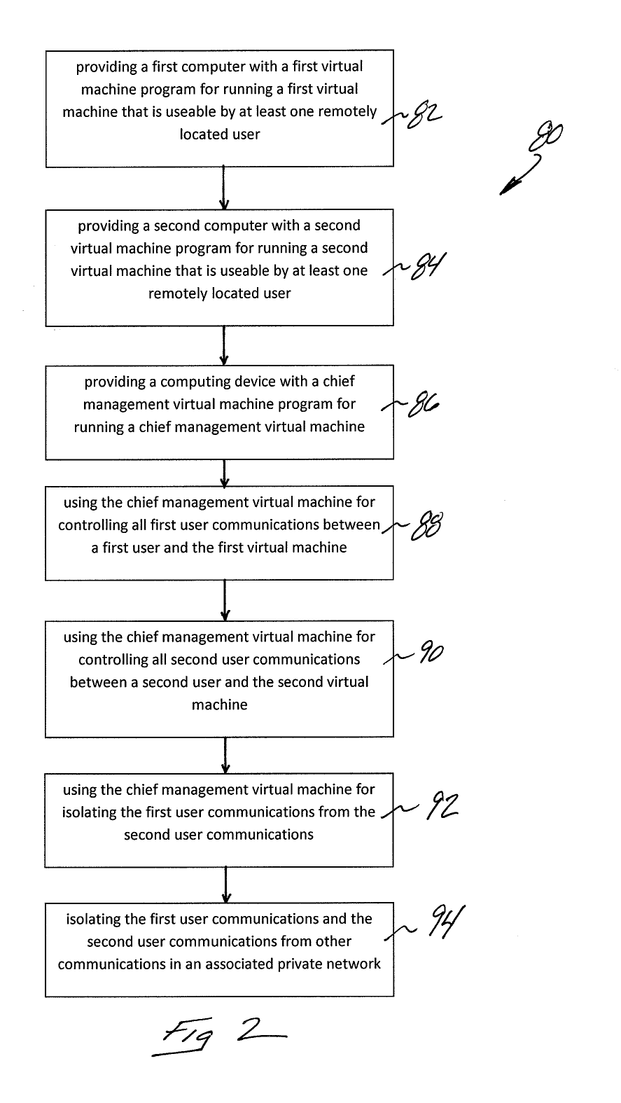

The illustrated example includes the capability to manage communications between remote users and the VMs associated with the personal cloud 40. FIG. 2 is a flow chart diagram 80 that summarizes one example method of controlling cloud computing using the example personal cloud 40. The example method includes providing a first computer with a first virtual machine program for running a first VM that is available to at least one remotely located first user as shown at 82. Providing a second computer with a second virtual machine program for running a second VM that is available to at least one remotely located second user is shown at 84. Each of the computers may run a plurality of VMs.

A compute device controller is provided with a chief management virtual machine program for running a chief management virtual machine at 86. This example includes using the chief management virtual machine for controlling first user communications between the first VM and the first user at 88. The chief management virtual machine is used at 90 for controlling second user communications between the second VM and the second user. The example method also includes using the chief management virtual machine at 92 for isolating the first user communications from the second user communications.

At 94 this example includes isolating the first user communications and the second user communications from any other traffic within the private network 22. This ensures that any use of the computers 30, 32 or 34 will not be compromised or interfered with by the communications between remote users and the VMs in the personal cloud 40.

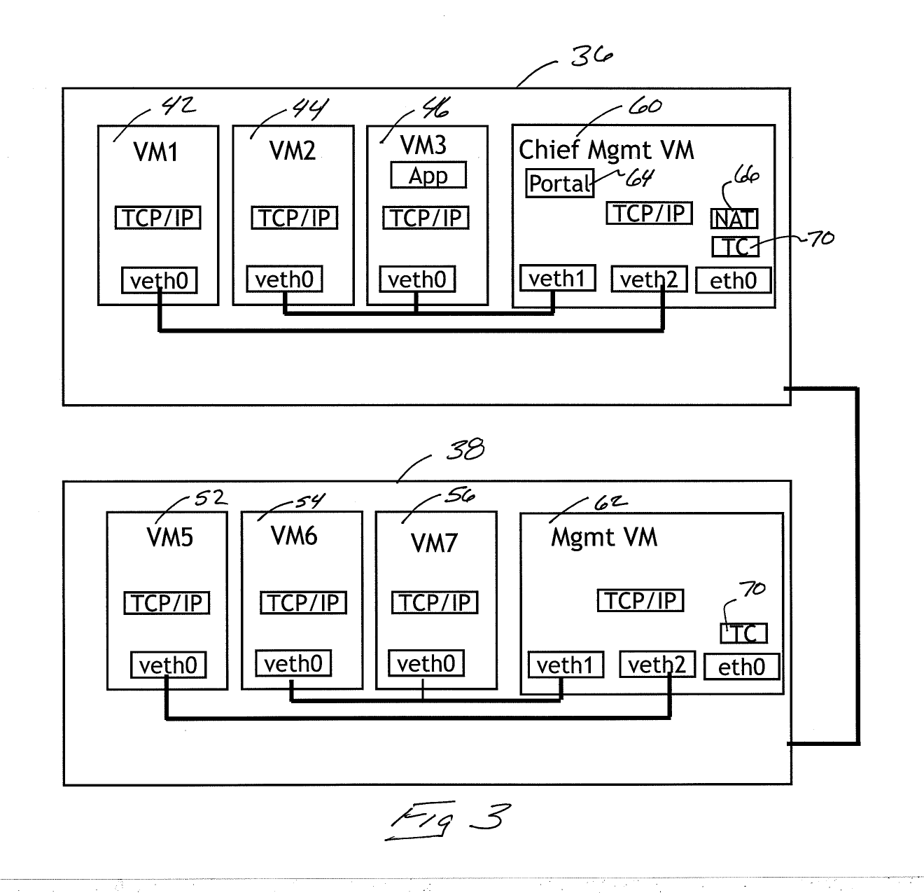

As shown in FIG. 3, each of the computers 36 and 38 are provided with at least one virtual machine program enabling the computer to run a plurality of VMs (i.e., instances of such a program). For discussion purposes, the computer 36 is described as running three VMs 42, 44 and 46. Any one or more of those VMs is available to at least one first user remote from the network 22. The computer 38 is described as running three VMs 52, 54 and 56. Any one of more of those VMs is available to at least one second user remote from the network 22. It is worth noting that a virtual network provided to a user may comprise VMs on more than one of the illustrated computers and the described example division of users among the computers 36 and 38 is for discussion purposes only. Additionally, more than one user may access or utilize the same VM simultaneously in some examples.

Each computer in FIG. 3 is also provided with a management virtual machine program. In this example, the computer 36 runs a management virtual machine 60 (e.g., an instance of the management virtual machine program) and the computer 38 runs a management virtual machine 62. Each management virtual machine (MVM) communicates with the VMs of the same computer and with other MVMs in the same personal cloud. The resources of the network 22 facilitate the communications between the MVMs.

In this example the MVM 60 is a chief MVM that acts as a gateway for controlling all communications between the cloud 40 and the external network 26. The chief MVM 60 controls all first user communications between a first user and any of the VMs provided by the computer 36. The chief MVM 60 controls all second user communications between a second user and any of the VMs provided by the computer 38. The chief MVM 60 ensures that the first user communications are isolated from the second user communications and any communications of users within the network 22.

One example includes managing incoming traffic by forwarding it to the chief MVM 60, which maps the incoming communication to the appropriate VM. One example includes using TCP and UDP port forwarding at the router 28 to forward a selected set of ports (e.g., corresponding to SSH and web traffic such at TCP ports 22, 80 and 443) to a management portal running in the chief MVM 60. There are known techniques that allow users to set up port forwarding on a home router.

Another example includes UPnP protocols like the IGD to programatically create network address translation (NAT) pinholes and port forwarding rules in UPnP compliant routers. In one example all SSH and web traffic is routed to the chief MVM 60. In some examples, all incoming traffic to the network 22 from the network 26 is routed to the chief MVM 60.

One example includes a two stage approach facilitated by the chief MVM 60 for providing users access to the individual VMs within the cloud 40. In the first stage, a potential cloud user provides trigger packets that indicate the source address of the user. In the example of FIG. 3, the user accesses a web portal 64 of the chief MVM 60 over the external network 26. After the chief MVM 60 authenticates the user based on information previously provided to or obtained by the chief MVM 60, the user is directed to a set of links representing the VMs that the user is running in the personal cloud 40. An appropriate protocol type for communications with that machine is assigned to an association of that user and that VM. In one example, the user selects the protocol. In another example, the protocol is automatically assigned. The chief MVM 60 directs subsequent traffic of that particular protocol type from the source address of that user to the selected VM.

The example chief MVM 60 includes a NAT module 66 for translating between addresses so that user communications are properly directed between a user and the appropriate VM. For example, a communication from a remote user will be directed to the IP address of the interface device (e.g., modem) 24. That communication gets routed to the chief MVM 60 by the router 28. The chief MVM 60 translates from the IP address of the interface device 24 to a private IP address of the appropriate VM based on the source address and protocol information mentioned above. For communications that originate from one of the VMs 52, 54 or 56, those will be directed to the chief MVM 60 from the MVM 62 using the internal IP address of the chief MVM 60. In some embodiments, the NAT module 66 translates from that address to the appropriate user address based on information regarding the source VM and the protocol for that communication.

In another example, each VM is accessed only over the Internet. The portal 64 is this example runs as a web router. Each web access (HTTP) request uniquely identifies the hostname to which it is addressed. Since each VM can have a different name while sharing the same IP address, this example allows for one stage demultiplexing at the portal 64 in the chief MVM 60.

The chief MVM 60 in this example is responsible for personal cloud automation including instantiating and deleting VMs, assigning VMs to users, assigning VMs to virtual networks, isolating and ensuring the security of traffic between VMs, ensuring quality of service for network traffic to and from the personal cloud 40, IP address sharing and application proxying across multiple VMs.

Controlling the first user communications between a first user and any of the VMs 52-56 includes using the MVM 62 to rate limit such traffic to regulate the bandwidth usage inside the network 22 and through the interface device 24 into the external network 26. The MVM 62 includes a traffic conditioning module 70 for regulating all traffic to or from any of the VMs 52-56 run by the computer 38. In one example, every computer in the cloud 40 has its own MVM and every MVM includes such a traffic conditioning module. Only the chief MVM 60 has the NAT module 66 and the portal 64 because all communications between VMs in the cloud 40 and the external network 26 pass through the chief MVM 60.

As mentioned above, personal cloud configurations consistent with the disclosed examples may be aggregated and used as a virtual, distributed cloud that allows a service provider to provide cloud computing without having to own or control the infrastructure needed for such a cloud.

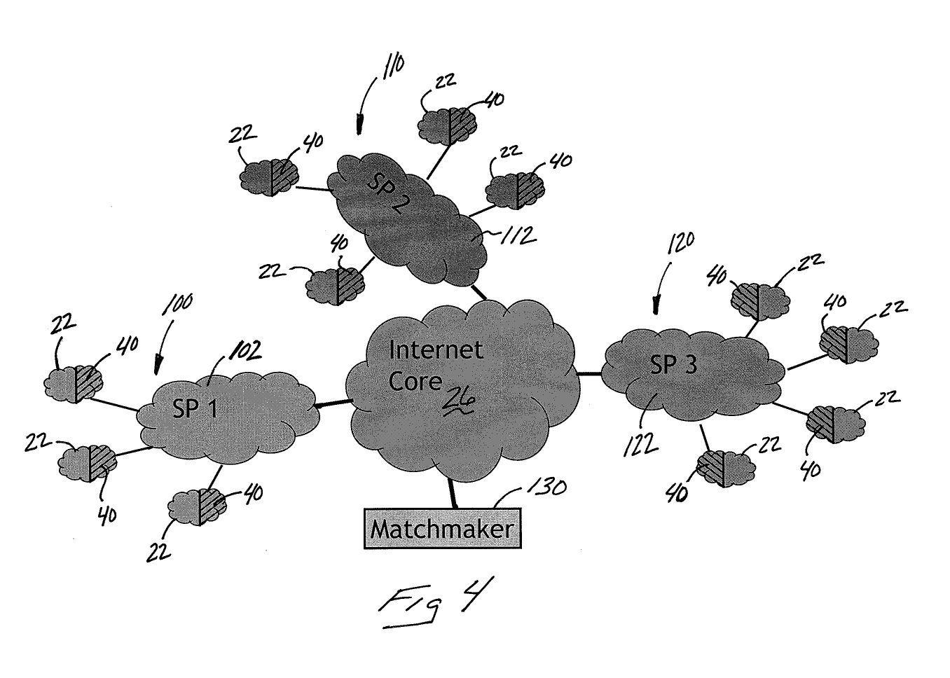

FIG. 4 schematically shows a plurality of virtual, distributed clouds that each comprises a plurality of personal clouds 40. In the illustrated example, a first virtual, distributed cloud 100 is provided by a service provider that operates a network 102. Each of a plurality of personal clouds 40 that are part of respective personal networks 22 is included in the virtual cloud 100. Another virtual cloud 110 is provided by a service provider that operates a network 112. A third example virtual, distributed cloud 120 includes other personal clouds 40 and is managed by a service provider that operates a network 122.

The illustrated example allows a service provider to offer cloud computing services without having to obtain or maintain the necessary infrastructure. Instead, the service provider utilizes the endpoint or edge compute resources available within the personal clouds 40.

FIG. 4 includes a matchmaker 130 that matches up VM offerings with requests. The matchmaker 130 may use one of a variety of matchmaking algorithms. The manner in which the matches are selected or optimized is outside the scope of this description.

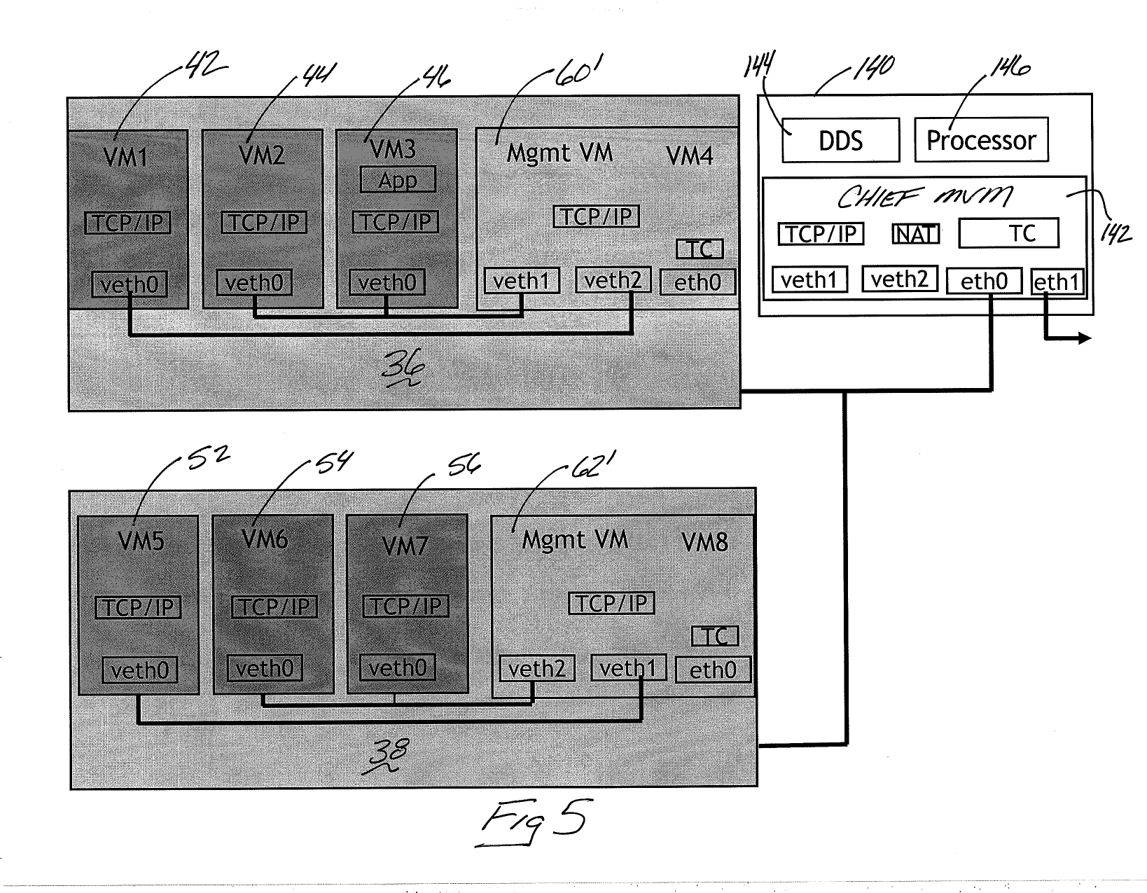

FIG. 5 schematically illustrates selected portions of an example virtual, distributed cloud arrangement. In this example, the computers 36 and 38 from one of the personal clouds 40 and a compute device controller 140 are shown. The chief MVM is not located at one of the computers 36 or 38. Similarly, there is no chief MVM within any of the computers of any other personal cloud 40 that is part of the virtual cloud. Instead, the virtual cloud service provider controls compute device controllers for running chief MVMs so that the personal clouds can be effectively aggregated into the virtual, distributed cloud.

In the illustrated example a compute device controller 140 runs the chief MVM 142. The device 140 is within the personal network 22 and in this example comprises a router with sufficient processor capacity for running the chief MVM 142. For example, the compute device controller 140 includes digital data storage 144 and a processor 146 associated with the digital data storage 144 for accessing programs and information in the storage and to alter contents of the storage as appropriate. When processor-executable programs such as the chief management virtual machine program are implemented on the processor 146, the program code segments combine with the processor 146 to provide a unique device that operates analogously to specific logic circuits.

In some such examples, the compute device controller 140 (e.g., a home router) is provided by and managed by the service provider that facilitates the virtual, distributed cloud. In another example the compute device controller 140 and the chief MVM 142 are centrally located remotely from the computers included in each of the personal clouds and operated by the service provider.

Having a chief MVM outside of the computers in the personal clouds 40 allows for centralized control over each personal cloud that is part of the virtual cloud. This type of arrangement allows for aggregating the resources of a plurality of distributed personal clouds for offering cloud computing services to users without having to purchase or maintain the infrastructure that is needed for the virtual cloud. The service provider or other entity that facilitates the virtual, distributed cloud may share revenue obtained from offering cloud computing as a service to those who make computers available within personal clouds to be part of the aggregate cloud. Alternatively, the service provider may provide a discount on other services provided to those who make a personal cloud available to be part of such a cloud that is an aggregate of a plurality of personal clouds 40. Such an arrangement allows individuals, for example, to realize some financial benefit from otherwise unused computers or other computing resources. A benefit to the service provider is that the service provider can offer more cloud computing services without investing in or maintaining the additional infrastructure that is needed.

In this example each computer 36 and 38 runs a MVM 60′ and 62′, respectively. Each of those MVMs communicates with the chief MVM 142, which manages all communications between the users and the VMs. None of the computers in the personal cloud 40 has to run a chief MVM in this example.

The operator of the chief MVM 142 verifies the personal network owners who participate in providing the resources for the aggregated cloud based on a pre-existing relationship between those individuals and the service provider in one example. The service provider enables the connectivity between the chief MVM 142, the personal clouds and any authorized users.

In the example of FIG. 5 a communication originating at the VM 46 goes through the MVM 60′ run by the computer 36 and to the chief MVM 142. In one example, layer 2 networking (L2) tunnels are set up between the MVMs 60′, 62′ and the chief MVM 142. The communication is then NATed by the chief MVM 142 and it flows out to the service provider network. In one example, each MVM maintains separate L2 tunnels to the compute device controller (e.g., home router) 140 for each virtual network that it hosts.

As the chief MVM functionality is removed from the computers 36 and 38 in this example, there is no need for any port forwarding to extend incoming traffic to the chief MVM 142.

Incoming communications intended for a VM in one example are handled using the two-stage approach described above. One difference is that the remote user contacts a portal located in the service provider's equipment in the first stage rather than in the home router associated with the VM. The service provider equipment programs the NAT module in the chief MVM 142 remotely.

The service provider in this example handles IP address management and bandwidth usage for traffic into each cloud. The MVMs 60′ and 62′ need only be responsible for regulating traffic or bandwidth usage within the personal cloud 40 and outgoing tunneled L2 traffic from the corresponding computer 36 or 38 to the compute device controller 140 over the L2 tunnel connections between them.

Differences between the examples of FIGS. 2 and 4 include the location of the chief MVM and in the latter case, there is no need for any port forwarding to extend incoming cloud traffic to a chief MVM on one of the computers. With a managed aggregate of personal clouds, the service provider in some examples does not use NAT but instead allocates addresses in the service provider's address space or public Internet space to each VM. This approach includes an ability to limit which users are able to access which VMs.

In one example, the service provider sets up L2 or layer 3 networking (L3) tunnels between the compute device controller 140 and a designated IP address for each customer. This allows virtual private network (VPN) access to the virtual network allocated to the customer. The VPN connection is connected to the L2 network allocated for the customer thereby sealing the L2 network from any other customer traffic or home network traffic. In this case the customer is responsible for allocating addresses to the VMs inside the VPN-based virtual private cloud (VPC) but since all remote access to the customer VMs is over the VPN connection, the service provider has no concern regarding access restrictions.

Several example uses of a personal cloud are disclosed above. Each may have features that are unique to that example but implementations of this invention are not necessarily so limited. It is possible to combine one or more features of one of the examples with one or more features of another. The disclosed examples provide personal cloud computing with appropriate resource management and communication confidentiality for realizing the benefits of cloud computing within a personal cloud environment.

The preceding description is exemplary rather than limiting in nature. The scope of legal protection given to this invention can only be determined by studying the following claims.

We claim:

1. A cloud computing apparatus, comprising:
at least one compute device controller including a digital data storage comprising a chief management virtual machine program for running a chief management virtual machine and a processor associated with the digital data storage, the processor being configured to run the chief management virtual machine to:
control first user communications between at least one first user and a first virtual machine,
control second user communications between at least one second user and a second virtual machine, wherein the first virtual machine and the second virtual machine are run by at least one compute resource distinct from the compute device controller, and
isolating the first user communications from the second user communications.

2. The apparatus of claim 1, comprising
a plurality of the compute device controllers provided with respective chief management virtual machine programs for running respective chief management virtual machines to:
control first user communications,
control second user, and
isolate the first user communications from the second user communications.

3. The apparatus of claim 2, wherein the plurality of compute device controllers are located remotely from each other, each of the compute device controllers is associated with at least one compute resource that is part of a private network and the plurality of compute device controllers are aggregated into a distributed cloud computing system.

4. The apparatus of claim 1, wherein the chief management virtual machine communicates with a management virtual machine on the at least one compute resource.

5. A cloud computing system, comprising:
at least one compute resource provided with a virtual machine program for:
running a first virtual machine that is available to at least one remotely located first user and
running a second virtual machine that is available to at least one remotely located second user; and
a compute device controller provided with a chief management virtual machine program for running a chief management virtual machine for:
controlling first user communications between the first virtual machine and the first user,
controlling second user communications between the second virtual machine and the second user, and
isolating the first user communications from the second user communications.

6. The system of claim 5, wherein
the at least one compute resource comprises a first compute resource and a second compute resource;
the second compute resource is the compute device controller;
the first compute resource is provided with a management virtual machine program for running another management virtual machine for controlling the first user communications including directing all first user communications to the chief management virtual machine.

7. The system of claim 6, wherein the management virtual machine run by the first compute resource controls an amount of bandwidth used for the first user communications.

8. The system of claim 7, wherein the chief management virtual machine controls an amount of bandwidth used for the second user communications.

9. The system of claim 8, wherein
the compute resources are associated with a private network having an amount of available bandwidth for communications within the private network;
the management virtual machine run by the first compute resource controls an amount of the available bandwidth used for the first user communications within the private network; and
the chief management virtual machine controls an amount of the available bandwidth used for the second user communications within the private network.

10. The system of claim 5, comprising
a router for interfacing between the virtual machines and an external network
and wherein
the chief management virtual machine controls the first user communications between the first virtual machine and the router and
the chief management virtual machine controls the second user communications between the second virtual machine and the router.

11. The system of claim 10, wherein
the router has a single Internet Protocol (IP) address for interfacing with the external network;
the chief management virtual machine assigns private IP addresses to each of the virtual machines;
the chief management virtual machine associates a source address of each of the users with a corresponding virtual machine; and
the chief management virtual machine processes any communications from the router that were addressed to the single IP address, determines the source address of the communications from the router and directs each of the communications to the private IP address of the virtual machine associated with the determined source address.

12. The system of claim 11, wherein the chief management virtual machine includes a network address translation module for receiving a communication from a virtual machine that was addressed to the chief management virtual machine and translating to an address of the one of the users that is an intended recipient of the communication.

13. The system of claim 5, wherein the chief management virtual machine:
facilitates each of the users providing trigger packets that identify a source address of the user,
authenticates the user,
facilitates the user indicating which of the virtual machines the user intends to access, and
associates the source address of the user with a port address of the indicated virtual machine for subsequently directing communications between the user and the indicated virtual machine.

14. The system of claim 5, wherein the compute device controller comprises a router configured to interface between the at least one compute resource and an external network.

15. The system of claim 14, wherein the at least one compute resource is provided with a management virtual machine program for running a management virtual machine for interfacing with the chief management virtual machine.

16. The system of claim 14, wherein the compute device controller is one of a plurality of compute device controllers each running a chief management virtual machine and the compute device controllers are aggregated into a distributed cloud system.

17. A method of cloud computing, comprising the steps of:
providing a plurality of compute device controllers with respective chief management virtual machine programs for running respective chief management virtual machines;
controlling first user communications between at least one first user and a first virtual machine;
controlling second user communications between at least one second user and a second virtual machine, wherein the first virtual machine and the second virtual machine are run by at least one compute resource distinct from the compute device controller; and
isolating the first user communications from the second user communications.

18. The method of claim 17, wherein the compute device controller comprises equipment that is operated by a service provider and the at least one compute resource comprises equipment operated by another distinct from the service provider.

19. The method of claim 17, wherein the chief management virtual machine communicates with a management virtual machine on the at least one compute resource.

20. The method of claim 17, wherein the plurality of compute device controllers are located remotely from each other, each of the compute device controllers is associated with at least one compute resource that is part of a private network and the method comprises aggregating the plurality of compute device controllers into a distributed cloud computing system.

21. A method of cloud computing, comprising the steps of:
providing at least one compute resource with a virtual machine program for:
running a first virtual machine that is available to at least one remotely located first user and
running a second virtual machine that is available to at least one remotely located second user;
providing a compute device controller with a chief management virtual machine program for running a chief management virtual machine;
using the chief management virtual machine for controlling first user communications between the first virtual machine and the first user;
using the chief management virtual machine for controlling second user communications between the second virtual machine and the second user; and
using the chief management virtual machine for isolating the first user communications from the second user communications.

22. The method of claim 21, wherein
the at least one compute resource comprises a first compute resource that runs the first virtual machine and a second compute resource that runs the second virtual machine;
the second compute resource is the compute device controller and the method comprises:
providing the first compute resource with a management virtual machine program for running another management virtual machine;
using the management virtual machine run by the first compute resource for controlling the first user communications including directing all first user communications to the chief management virtual machine and controlling an amount of bandwidth used for the first user communications.

23. The method of claim 22, comprising using the chief management virtual machine for controlling an amount of bandwidth used for the second user communications.

24. The method of claim 21, wherein the compute resources are associated with a private network including a router for interfacing between the virtual machines and an external network, the router having a single Internet Protocol (IP) address for interfacing with the external network, and wherein the method comprises:
using the chief management virtual machine for assigning private IP addresses to each of the virtual machines;
using the chief management virtual machine for associating a source address of each of the users with a corresponding virtual machine; and
using the chief management virtual machine for processing any communications from the router that were addressed to the single IP address;
using the chief management virtual machine for determining the source address of the communications from the router; and
using the chief management virtual machine for directing each of the communications to the private IP address of the virtual machine associated with the determined source address.

25. The method of claim 24, wherein the chief management virtual machine includes a network address translation module for receiving a communication from a virtual machine that was addressed to the chief management virtual machine and translating to an address of the one of the users that is an intended recipient of the communication.

26. The method of claim 21, comprising:
using the chief management virtual machine for facilitating each of the users providing trigger packets that identify a source address of the user,
using the chief management virtual machine for authenticating the user,
using the chief management virtual machine for facilitating the user indicating which of the virtual machines the user intends to access, and
using the chief management virtual machine for associating the source address of the user with a port address of the indicated virtual machine for subsequently directing communications between the user and the indicated virtual machine.

27. The method of claim 21, wherein the compute device controller comprises a router configured to interface between the at least one compute resource and an external network.

28. The method of claim 21, comprising providing the at least one compute resource with a management virtual machine program for running a management virtual machine for interfacing with the chief management virtual machine.

29. The method of claim 21, wherein the compute device controller is one of a plurality of compute device controllers each running a chief management virtual machine and the method comprises aggregating the compute device controllers into a distributed cloud system.
